(19) United States
(12) Patent Application Publication
(10) Pub. No.: US 2016/0108671 A1
(43) Pub. Date: Apr. 21, 2016

(54) CUSTOM MOLD PRESS LADDER

(71) Applicants: COMPAGNIE GENERALE DES ETABLISSEMENTS MICHELIN, Clermont-ferrand (FR); MICHELIN RECHERCHE ET TECHNIQUE S.A., Granges-paccot (CH)

(72) Inventor: Andrew Stephan Cale, Greenville, SC (US)

(21) Appl. No.: 14/892,467

(22) PCT Filed: Aug. 8, 2014
(86) PCT No.: PCT/US2014/050320

§ 371 Date: Nov. 19, 2015

Related U.S. Application Data
(60) Provisional application No. 61/864,676, filed on Aug. 12, 2013.

(51) Int. Cl. E06C 1/39; E06C 1/397; E06C 9/12; E06C 7/18

(52) U.S. Cl. CPC E06C 1/39; E06C 7/182; E06C 1/397; E06C 9/12

(57) ABSTRACT

A ladder that employs an existing custom mold press frame to support itself thereon is provided along with a method of installation. A clamping engagement system employed by such a ladder is also provided along with a kit for installing the ladder with a mold press frame.

### TECHNICAL FIELD

The presently disclosed apparatus is generally directed to ensuring safe operation and maintenance of custom mold process vessels. More particularly, the presently disclosed apparatus is directed to an access and egress means for operation and maintenance personnel to safely work in and around custom mold presses.

### BACKGROUND

Several solutions exist for tire retreading processes that employ mold cure retreading. Custom mold retreads may be cured in multi-segment presses (e.g., 10-segment presses) to provide uniformity and allow for complex and deeper tread designs. The tire casing is measured and selected for a precise fit into the mold and is cured to exact times based on the tread design selected. Custom mold retreads nay be cured to manufacturer-specified protocols for time, temperature, and pressure.

During mold cure retreading, uncured tread rubber is applied to a buffed tire carcass that is placed into a rigid mold incorporating a tread design. Upon heating the mold (e.g., at temperatures from about 120° C. to about 150° C.), the uncured rubber flows and adheres to the tire, resulting in a tire appearance similar to that of a new tire. Because mold cure retreading processes are amenable to versatile tread patterns and extensive repairs, custom molds are often employed to fulfill customer tread performance requirements. As used herein, “custom mold” and “custom molding” refer, without limitation, to the respective devices and processes that employ mold cure retreading as described herein and also employ additional processes as known in the art.

A separate mold is required for each tread and size, requiring a large investment in the operation and maintenance of a range of molds. Such molds are disposed in a mold press, an example of which is mold press 10 shown in FIG. 1. Mold press 10 may include a frame 10a that may have one or more frame supports 10b as shown. Press frame 10a includes an outer surface 10a′ and an inner surface 10a″ with the latter delineating a recess 10c in which at least one mold is disposed during custom mold retread processes. Mold press 10 is an example of a variety of commercially available mold presses that are amenable for use in mold cure retreading systems.

Operators, technicians and maintenance personnel (collectively, “personnel” and “service personnel”) must often climb into and out of custom mold presses to insert and remove the molds, clean the molds and/or complete required preventive maintenance on the molds. Such personnel not only come into proximity of the flowing rubber at elevated temperatures. They also approach adjacent machinery that may be subject to operation in concert with the mold presses. Such conditions contribute to potentially unsafe environments for the personnel as well as reduced efficiency of the employed retread process.

Accordingly, improved access to and egress from custom mold presses would not only benefit the overall safety of custom mold personnel but also contribute to more efficient production in custom mold facilities.

### SUMMARY

A custom, mold press ladder is provided that employs an existing custom mold press frame to support itself thereon. The ladder includes a ladder frame having a pair of elongate members depending generally in parallel relative to one another with a predetermined distance defined therebetween. Each elongate member has a predetermined length coextensive with a support extent and an opposed free extent. One or more steps are securely disposed between the elongate members so as to support a person stepping thereon. A platform is provided that includes a predetermined platform length and a predetermined platform width generally corresponding to the predetermined distance between the elongate members. The platform is supported along a length of the elongate members intermediate the support extents and free extents thereof. The platform includes a support surface and an opposed anchoring surface from which an anchor depends downwardly to facilitate initial installation and securement of the ladder relative to the mold press frame. The ladder also includes a pair of scaffold members depending upwardly from the platform support surface in parallel relation to one another. The scaffold members are separated by a distance about equal to the predetermined platform width, with each scaffold member having a predetermined height coextensive with a fixed scaffold extent and an opposed free scaffold extent. The ladder is provided with at least one grab bar having opposed free extents removably secured to corresponding free extents of the elongate members and the scaffold members. A clamping engagement system removably secures the ladder to the mold press frame.

The clamping engagement system may include at least one of an articulating clamp and a safety clamp. The articulating clamp can include a pair of arms in operable communication with one another via a link. Operation of a clamp handle opens and closes the arms relative to one another, with each arm having a free extent that engages at least a portion of the mold press frame. The safety clamp includes a clamp handle for transmitting movement to a stop that frictionally engages the mold press frame. The articulating clamp may be provided proximate the support extent. The safety clamp may be provided along a length of the elongate members intermediate the articulating clamp and the anchor. A notch may be optionally provided in one or both of the free arm extents. Each notch has edges for engagement with at least a portion of the mold press frame.

The scaffold members may depend upwardly from a leading edge of the platform.

A pair of grab bars may be provided in generally parallel relation to one another and separated by a distance about equal to the predetermined platform width. Each grab bar is hingedly maneuverable relative to the elongate members and the scaffold members.

The ladder may also include one or more wheels in operable communication with the support extent of each elongate member for transporting the ladder. The ladder may instead include a fixed leg disposed at the support extent of each elongate member for supporting the ladder in a stationary position. In some embodiments, the ladder may be modular in that the wheels and legs may be selectively substituted for one another to change the ladder between a transport state and a stationary state.

A clamping engagement system is also provided for use with a ladder as presently disclosed herein.

Further provided is a method for installing an access and egress apparatus on a custom mold press. The method includes providing a ladder as presently disclosed and transporting the ladder to a location along a mold press frame. The ladder is lifted on to the mold press frame such that an anchor engages the frame. The clamping engagement system is brought into engagement with the mold press frame to ensure securement.

A kit is also provided for installing a ladder as presently disclosed with a mold press frame.

Other aspects of the presently disclosed apparatus will become readily apparent from the following detailed description.

### BRIEF DESCRIPTION OF THE DRAWINGS

The nature and various advantages of the present invention will become more apparent upon consideration of the following detailed description, taken in conjunction with the accompanying drawings, in which like reference characters refer to like parts throughout, and in which:

FIG. 1 shows an exemplary environment in which an exemplary custom mold press ladder is installed relative to an existing mold press.

FIGS. 2 and 3 show respective top perspective and bottom perspective views of the custom mold press ladder of FIG. 1.

FIG. 4 shows a partial perspective view of the of the custom mold ladder of FIG. 1 and an exemplary clamp engagement system thereof.

FIG. 5 shows a partial perspective view of the custom mold ladder of FIG. 1 and exemplary grab bars thereof in an upright position.

FIG. 6 shows the exemplary grab bars of FIG. 5 in a collapsed position.

FIGS. 7 to 11 show exemplary installation of a custom mold ladder as presently disclosed.

### DETAILED DESCRIPTION

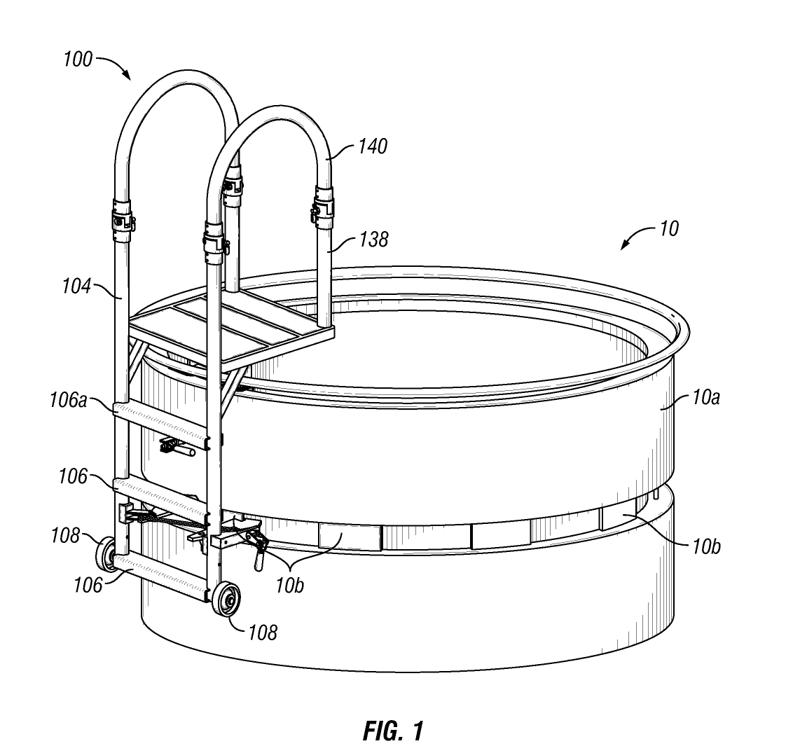

Now referring to the figures, wherein like numbers represent like elements, FIG. 1 shows a custom mold ladder 100 as an access and egress means for mold press 10. Ladder 100 employs an existing custom mold press frame 10a to support itself (as further described herein). It is understood that ladder 100 is amenable for use with a variety of mold presses and is not limited to use with mold press 10 as shown.

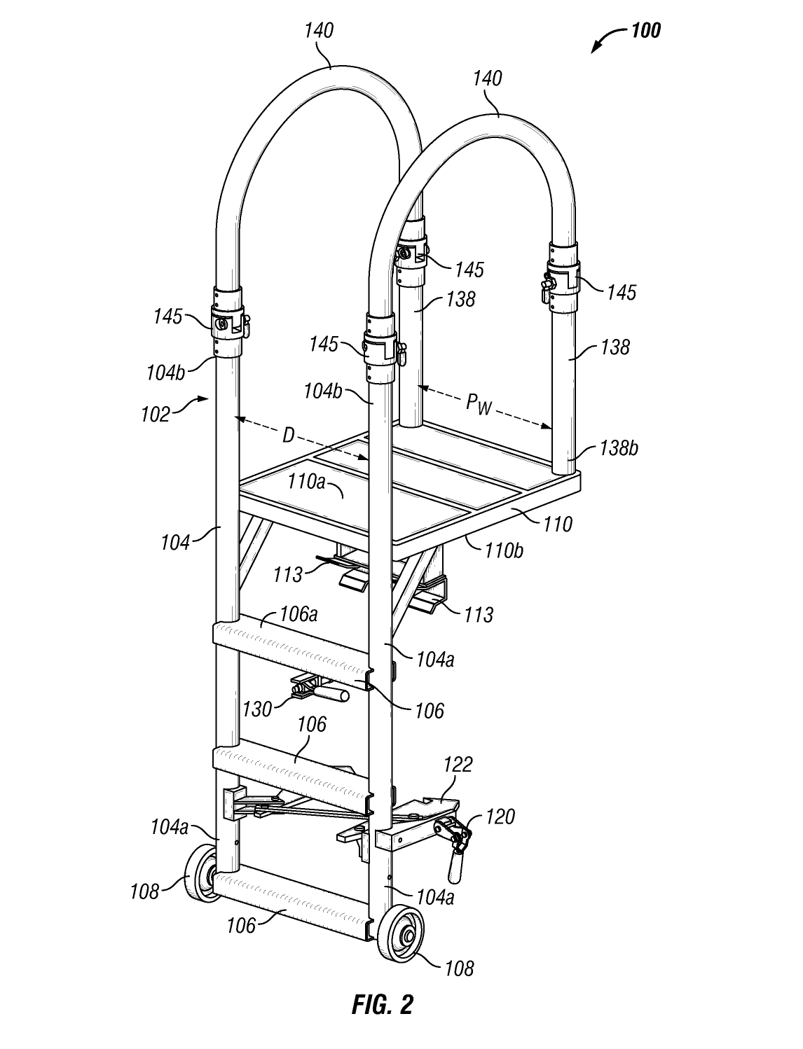

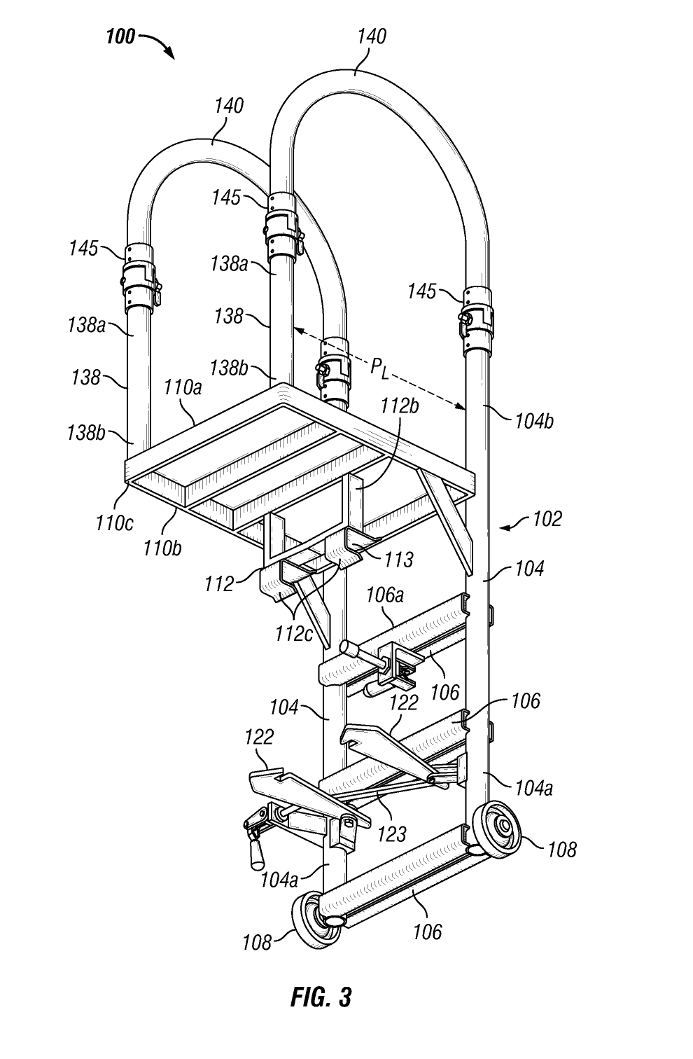

Referring further to FIG. 1 and additionally to FIGS. 2 and 3, ladder 100 includes a ladder frame 102 having a pair of elongate members 104 each having a predetermined length extending between a support extent 104a and a free extent 104b. Elongate members 104 depend generally in parallel relative to one another with a predetermined distance D defined therebetween. One or more steps 106 may be securely disposed along the elongate members' length so as to traverse distance D and support the weight of a person stepping thereon. Although three steps are shown in the figures, it is understood that fewer or more steps may be employed without departing from the scope of this disclosure. Distance D, while being adjustable to a plurality of personnel and conditions, should be sufficient to permit securement of steps 106 with elongate members 104 and also to facilitate passage of personnel between the elongate members.

Optional means for transporting ladder 100 may be provided (e.g., along a perimeter of a single mold press, between adjacent mold presses, from one location to another in a retreading facility, etc.). As shown herein, such transport means are provided as one or more wheels 108 in operable communication with support extent 104a of each elongate member 104. As shown herein, a step 106 is provided directly between wheels 108, although it is understood that the positioning of such a step is variable (e.g., there may be no step located between wheels 108, or the step may be offset from the rotational axes of wheels 108). Although one wheel 108 is shown at each support extent 104a, it is understood that more than one wheel may be so positioned. It is also understood that equivalent and/or complementary transport means may be used instead of wheels 108 (e.g., one or more roller bearings, etc.). It is additionally understood that ladder 100 may be provided without any wheels and may instead have fixed legs (not shown) that impede any rolling or sliding movement of the ladder. In some embodiments, there may be a modular option provided at each support extent 104a that permits fixed legs and wheels to be substituted for one another, thereby permitting alteration of the ladder between a transport state and a stationary state.

Referring still to FIGS. 2 and 3, elongate members 104 support a platform 110 along the length thereof intermediate a topmost step 106a and free member extents 104b. Platform 110 includes a support surface 110a upon which personnel are supported while servicing the mold press and an anchoring surface 110b from which an anchor 112 depends downwardly (as further described herein). Platform 110 has a predetermined width P_{w} generally corresponding to predetermined distance D so that personnel remain safely supported by ladder 100 when the ladder is installed with the mold press. Platform 110 also has a predetermined length Pₗ sufficient to safely support personnel thereon and provide reliable access to, and egress from, the mold press during servicing. As used herein, “servicing” includes, but is not limited to, inserting and removing molds into and from the mold press, cleaning the molds, completing required maintenance on the molds and/or the press and any other activities regularly performed by personnel to ensure optimal performance of the molds and mold press.

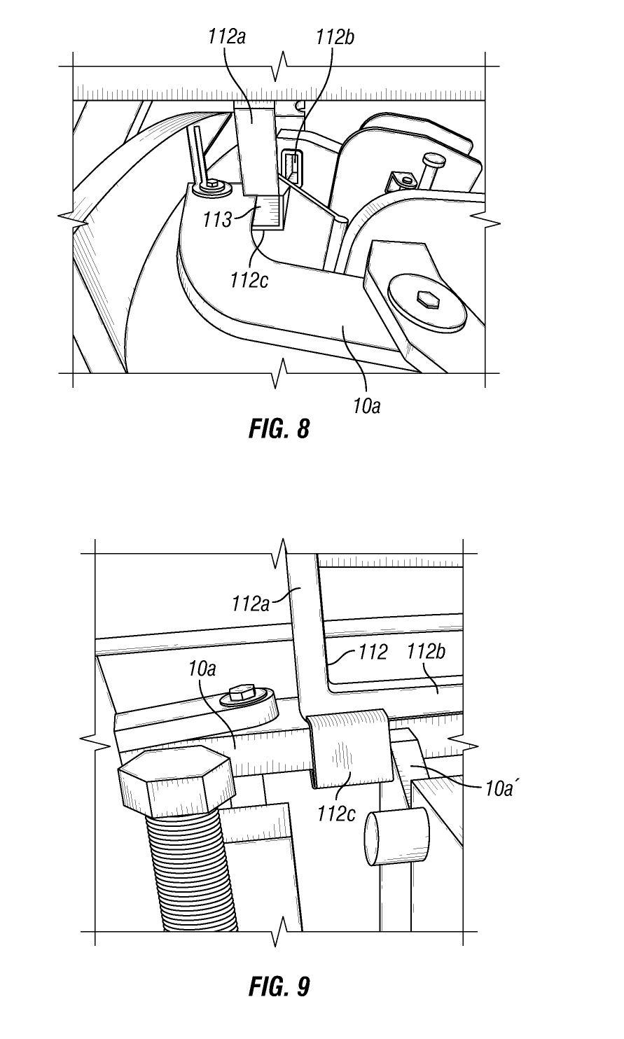

Anchor 112 depends downwardly from platform anchor surface 110b to facilitate initial installation and securement of ladder 100 relative to the mold press. Anchor 112 may include at least one generally depending member 112a that terminates in a support link 112b from which one or more supports 112c depend. In some embodiments there may be a single depending member from which supports 112c depend. In some embodiments, such as the exemplary embodiment shown in FIGS. 2 and 3 (and further shown in FIGS. 8 and 9), two or more depending members may be provided in parallel alignment and having a predetermined distance therebetween (which distance may be varied in relation to the type of mold press with which ladder 100 is being installed). As shown in the exemplary embodiment, a pair of supports 112c is provided in an embodiment in which each support 112c includes a profile that delineates a support channel 113 for ladder 100 to engage at least a portion of the mold press frame. Support channel 113 may exhibit a C-shaped or U-shaped profile. In some embodiments, supports 112c may have other profiles that are amenable to operation of ladder 100.

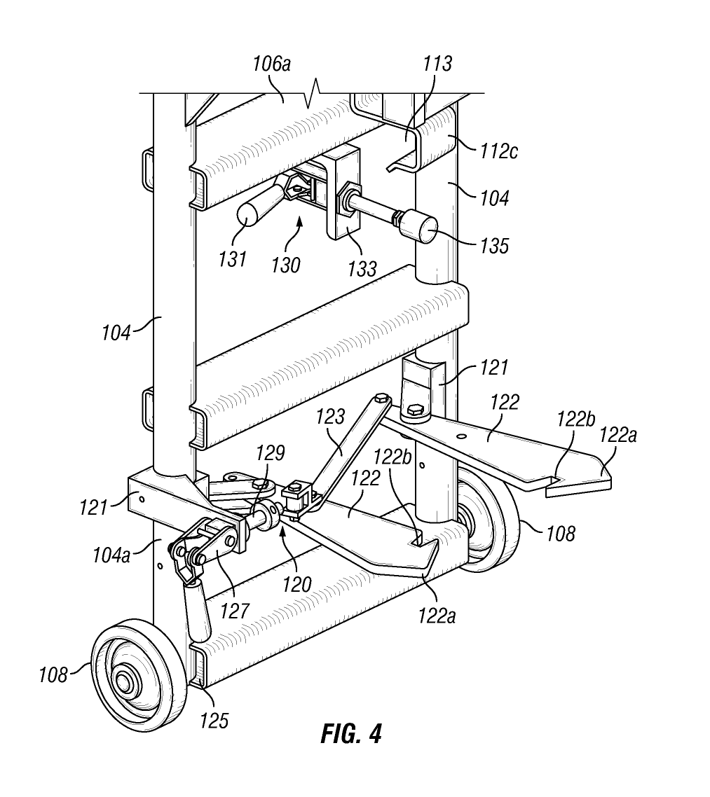

Referring further to FIG. 4, a clamping engagement system may be provided with ladder 100 for additional securement to the mold press. The clamping engagement system includes at least one of an articulating clamp 120 and a safety clamp 130. Articulating clamp 120 may be integral with or affixed to ladder frame 102 by one or more ladder brackets 121 or by any other equivalent and/or complementary attachment means. Articulating clamp 120 includes a pair of actuatable arms 122 in operable communication with one another via a link 123. Each arm 122 includes a free extent 122a that engages at least a portion of the mold frame (e.g., at frame support 10b of mold frame 10a as shown in FIGS. 1, herein).

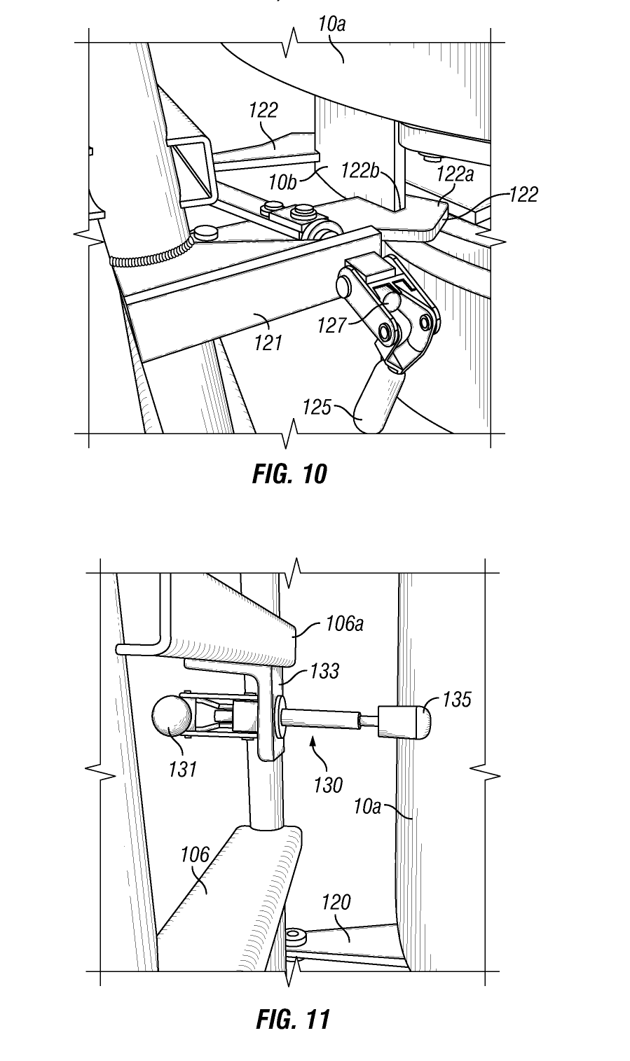

An optional notch 122b may be provided in one or both of free arm extents 122a to ensure secure engagement of each arm with the frame along the edges of each notch 122b (e.g., see an exemplary engagement of notches 122b with frame support 10b in FIG. 10). A clamp handle 125 is rotatably supported by a handle bracket 127 such that rotation of clamp handle 125 transmits motion through an auxiliary arm 129 to link 123. Selective operation of clamp handle 125 translates into opening and closing of arms 122 relative to one another.

In some embodiments, as further shown in FIG. 4, a safety clamp 130 is provided that includes a clamp handle 131. Safety clamp may be integral with or affixed to ladder frame 102 by one or more safety clamp brackets 133 or by any other equivalent and/or complementary attachment means. Safety clamp 130 includes an actuatable stop 135 that engages at least a portion of a mold frame (e.g., stop 135 may engage mold frame 10a as shown in FIG. 11). Clamp handle 131 may be hingedly connected with bracket 133 and stop 135 such that articulation of clamp handle 131 positions stop 135 to frictionally engages the mold press.

In the embodiments shown, articulating clamp 120 and safety clamp 130 are depicted at relative distances to the elongate members and to one another. In an embodiment as shown in FIGS. 2 to 4, an articulating clamp 120 is provided proximate support extents 104a. In an embodiment as shown in the same figures, safety clamp 130 is provided along a length of elongate members 104 intermediate articulating clamp 120 and anchor 112. It is understood that the location of at least one of articulating clamp 120 and safety clamp 130 may be adjusted in accordance with the parameters of the mold press and the physical attributes of the person performing service.

One or more scaffold members 138 are provided that depend upwardly from platform support surface 110a. In some embodiments, such as the exemplary embodiment shown in FIGS. 2 and 3, scaffold members are provided in parallel relation to one another and separated by a distance about equal to the predetermined platform width P. Each scaffold member 138 has a predetermined height coextensive with a free scaffold extent 138a and an opposed fixed scaffold extent 138b secured on platform support surface 110a. In some embodiments, scaffold members 138 depend upwardly from a leading edge 110c of platform 110, thereby providing service personnel with a visual indication of the platform edge.

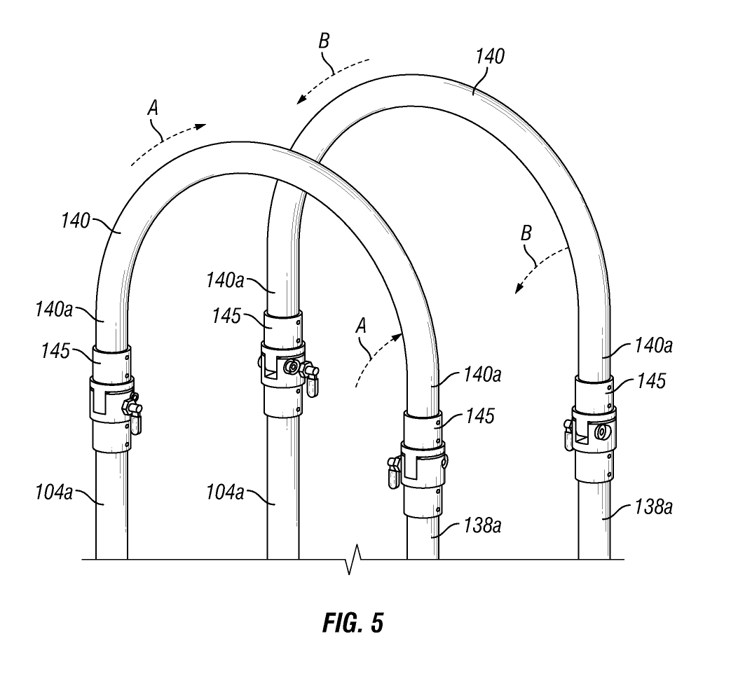

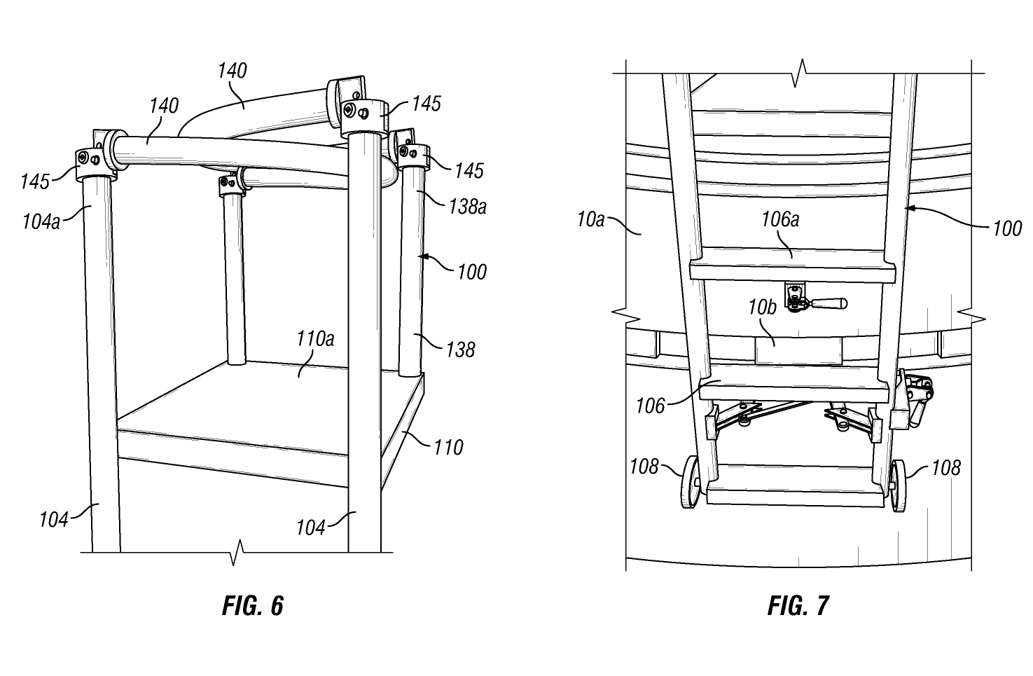

As an additional safety feature, some embodiments of ladder 100 include at least one grab bar 140 having opposed free extents 140a removably secured to corresponding free extents 104a and 138a of elongate members 104 and scaffold members 138, respectively. Each grab bar 140 may be hingedly maneuverable relative to a free extent 104a of corresponding elongate member 104. As shown in FIG. 1 and further illustrated in FIGS. 5 and 6, a pair of grab bars 140 may be provided in generally parallel relation to one another and separated by a distance about equal to the predetermined platform width P. As shown herein, each grab bar exhibits a generally C-shaped or U-shaped geometry for ready grasping by service personnel, although other geometries are contemplated that are amenable to practice of the presently disclosed invention. At least a portion of one or more grab bars 140 may have a gripping surface integral therewith or placed thereon to provide personnel with additional securement while grasping grab bars 140. In embodiments that include grab bars 140, the placement of scaffold members 138 at or near platform leading edge 110c facilitates proper installation of the grab bars for intuitive use by service personnel.

In the embodiments shown, free extents 140a of grab bars 140 are removably secured to respective free extents 104a of elongate members 104 and free extents 138a of scaffold members 138. As shown in FIG. 5, securement is established by hinge couplings 145, although any equivalent and complementary securement means may be employed. Hinge couplings 145 enable rotation of grab bars 140 in the direction of arrows A and B (see FIG. 5) relative to elongate members 104 and scaffold members 138. As shown in FIG. 6, the rotation of grab bars 140 allows the grab bars to collapse over platform support surface 110a, thereby impeding inadvertent access to platform 110 by service personnel. The selective folding of grab bars 140 promotes additional safety protocols by providing clearance for additional machinery or parts that may pass over ladder 100 (e.g., the grab bars are folded to allow for a tire lifting arm on the press to maneuver above the ladder while the ladder is mounted on the press). The collapsed grab bars serve as both visual and tactile indicia to service personnel that not only alert the personnel to potential safety conditions but also impede access to the ladder while a potentially unsafe condition exists. When the condition subsides and servicing in considered safe, the personnel can easily elevate grab bars 140 to the upright position (e.g., as shown in FIG. 5) and thereby indicate to other personnel that access to the mold press is now permitted.

In some embodiments, an additional structural piece (not shown) may be mounted to the mold press that may then be used to lock ladder 100 to the press. Such embodiments are within the scope of the present disclosure.

An exemplary installation of ladder 100 with a mold press is now described with reference to mold press 10 of FIG. 1. It is understood, however, that similar installation processes may be exercised for the installation of ladder 100 with other mold press configurations as would be readily understood by a skilled person.

Referring to FIGS. 7 to 11, ladder 100 is transported (e.g., by wheels 108) to a location along the press (e.g., along a periphery of press frame 10a as shown in FIG. 1). In preferred embodiments, the centerline L_{c} of ladder 100 is centered with frame support 10b with articulating clamp 120 and safety clamp 130 in retracted positions (see FIG. 7). Ladder 100 is lifted on to press frame 10a such that anchor 112, and namely support channel 113 thereof, engages frame 10a (see FIG. 8). A gusset 10a′ of frame 10a may be employed as a stop for anchor 112 as ladder 100 is installed (see FIG. 9).

Articulating clamp 120 is aligned with frame support 10b such that arms 122 (and particularly notches 122a of those embodiments incorporating such notches) are ready to engage opposing sides of the frame support (see FIG. 10). Actuation of clamp handle 125 causes link 123 to articulate arms 122 toward one another such that they securely grasp frame support 10b thereby. Upon full engagement of articulating clamp 120, clamp handle 131 of safety clamp 130 is actuated until the safety clamp fully engages mold press frame 10a (see FIG. 11). Installation of ladder 100 may be performed with grab bars 140 in an upright position (as shown in FIG. 5) or in a collapsed position (as shown in FIG. 6). To remove or reposition ladder 100, the disclosed actions are conducted in reverse order to ensure safe removal of the ladder.

Ladder 100 may be fabricated from a variety of materials. Ladder frame 102 (including one or more of elongate members 104), scaffold members 138 and grab bars 140 may be selected from generally tubular elements that are fabricated from 6061-T6 aluminum or equivalent material. Hinge couplings 145 may be fabricated from 1020 cold rolled steel or any equivalent material that promotes extended life and increases the strength of the ladder. Articulating clamp 120 and/or arms 122 thereof may be constructed from 7075 aluminum or any equivalent material that facilitates weight reduction without compromising strength and wear resistance as necessary for operation of the ladder as disclosed.

The presently disclosed mold ladder enables the safe ingress and egress of service personnel relative to custom mold presses with minimal temporal and fiscal expenditures. The presently disclosed ladder utilizes the existing custom mold press frame to support itself. The ladder is therefore adaptable to a variety of mold press configurations while exhibiting a number of safety features. The presently disclosed custom mold ladder further preserves the efficiency and reliability of the cure mold retread processes being executed by the press while promoting the safety of all associated personnel.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross-referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the disclosed apparatus have been illustrated and described, it will be understood that various changes, additions and modifications can be made without departing from the spirit and scope of the present disclosure. Accordingly, no limitation should be imposed on the scope of the presently disclosed invention, except as set forth in the accompanying claims.

What is claimed is:

1. A ladder that employs an existing custom mold press frame to support itself thereon, comprising:
a ladder frame having a pair of elongate members depending generally in parallel relative to one another with a predetermined distance defined therebetween, with each elongate member having a predetermined length coextensive with a support extent and an opposed free extent;
one or more steps securely disposed between the elongate members so as to support a person stepping thereon;
a platform having a predetermined platform length and a predetermined platform width generally corresponding to the predetermined distance between the elongate members, the platform being supported along a length of the elongate members intermediate the support extents and free extents thereof and including a support surface and an opposed anchoring surface from which an anchor depends downwardly to facilitate initial installation and securement of the ladder relative to the mold press frame;
a pair of scaffold members depending upwardly from the platform support surface in parallel relation to one another and separated by a distance about equal to the predetermined platform width, with each scaffold member having a predetermined height coextensive with a fixed scaffold extent and an opposed free scaffold extent;
at least one grab bar having opposed free extents removably secured to corresponding free extents of the elongate members and the scaffold members; and
a clamping engagement system for removable securement of the ladder to the mold press frame.

2. The ladder of claim 1, wherein the anchor includes at least one depending member terminating in a support link from which one or more supports depend and each support includes a support channel for the ladder.

3. The ladder of claim 2, wherein at least a pair of depending members is provided in parallel alignment and having a predetermined distance between adjacent depending members, with

[symbol]

4. The ladder of claim 3, wherein each support depending from the support link includes a profile that delineates a support channel for the ladder.

5. The ladder of claim 2, wherein the clamping engagement system comprises at least one of:
an articulating clamp including a pair of arms in operable communication with one another via a link such that operation of a clamp handle opens and closes the arms relative to one another, with each arm having a free extent that engages at least a portion of the mold press frame; and
a safety clamp that includes a clamp handle for transmitting movement to a stop that frictionally engages the mold press frame.

6. The ladder of claim 5, wherein the articulating clamp is provided proximate the support extent and the safety clamp is provided along a length of the elongate members intermediate the articulating clamp and the anchor.

7. The ladder of claim 5, wherein a notch is optionally provided in one or both of the free arm extents and each notch having edges for engagement with at least a portion of the mold press frame.

8. The ladder of claim 2, wherein the scaffold members depend upwardly from a leading edge of the platform.

9. The ladder of claim 8, wherein a pair of grab bars is provided in generally parallel relation to one another and separated by a distance about equal to the predetermined platform width with each grab bar being hingedly maneuverable relative to the elongate members and the scaffold members.

10. The ladder of claim 1, further comprising one of:
one or more wheels for transporting the ladder, wherein the one or more wheels are in operable communication with the support extent of each elongate member; or
a fixed leg disposed at the support extent of each elongate member for supporting the ladder in a stationary position.

11. The ladder of claim 10, wherein the one or more wheels and the fixed legs are selectively substituted for one another.

12. A clamping engagement system for use with a ladder according to claim 1, comprising at least one of:
an articulating clamp including a pair of arms in operable communication with one another via a link such that operation of a clamp handle opens and closes the arms relative to one another, with each arm having a free extent that engages the mold frame; and
a safety clamp that includes a clamp handle for transmitting movement to a stop that frictionally engages the mold press frame.

13. A method for installing an access and egress apparatus on a custom mold press, comprising:
providing a ladder according to claim 1;
transporting the ladder to a location along a mold press frame;
lifting the ladder on to the mold press frame such that an anchor engages the frame; and
bringing the clamping engagement system into engagement with the mold press frame

14. The method of claim 12, wherein the anchor includes a channel that engages the mold press frame when the ladder is placed thereon.

15. The method of claim 12, wherein the clamping engagement system includes at least one of:
an articulating clamp including a pair of arms in operable communication with one another via a link such that operation of a clamp handle opens and closes the arms relative to one another, with each arm having a free extent that engages the mold frame; and
a safety clamp that includes a clamp handle for transmitting movement to a stop that frictionally engages the mold press frame.

16. The method of claim 14, wherein the ladder has a centerline that is positioned proximate the mold press frame with the articulating clamp and safety clamp in retracted positions.

17. The method of claim 15, further comprising aligning the articulating clamp with the mold press frame such that the arms readily engage opposing sides of a frame support upon actuation of a clamp handle in communication therewith.

18. The method of claim 16, further comprising providing a pair of grab bars in generally parallel relation to one another with each grab bar being hingedly maneuverable relative to the elongate members and the scaffold members.

19. The method of claim 17, wherein the grab bars are rotated toward the platform support surface into a collapsed position.

20. A kit for installing a ladder with a mold press frame, comprising:
a ladder according to claim 1; and
instructions for installing the ladder on the mold press frame.
